(19) United States
(12) Patent Application Publication
(10) Pub. No.: US 2006/0017682 A1
(43) Pub. Date: Jan. 26, 2006

(54) Display panel driving device and flat display device

(76) Inventor: Seiji Kawaguchi, Hirakata-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/183,992

(22) Filed: Jul. 19, 2005

(30) Foreign Application Priority Data
Jul. 20, 2004 (JP) 2004-211266

(51) Int. Cl. G09G 3/36

(52) U.S. Cl. 345/98

(57) ABSTRACT

A display panel driving device for an OCB-mode liquid crystal display panel comprises gate and source drivers which are connected to the liquid crystal display panel, and a voltage supply circuit which supplies video signal reference voltages and black insertion reference voltages to the source driver. In particular, the voltage supply circuit is configured to independently generate the video signal reference voltages and the black insertion voltages.

### CROSS-REFERENCE TO RELATED APPLICATIONS

This application is based upon and claims the benefit of priority from prior Japanese Patent Application No. 2004-211266, filed Jul. 20, 2004, the entire contents of which are incorporated herein by reference.

### BACKGROUND OF THE INVENTION

1. Field of the Invention

The present invention generally relates to a display panel driving device and flat display device, particularly to a display panel driving device and flat display device which are suitably applicable to a liquid crystal display panel using an OCB technique for realizing a wide viewing angle and high-speed response.

2. Description of the Related Art

Currently, liquid crystal display panels having characteristics such as lightness, thinness, and small power consumption are used as displays for television receivers, personal computers and car navigation systems.

A twisted nematic (TN) mode liquid crystal display panel widely utilized as such a liquid crystal display panel is configured such that a liquid crystal material having optically positive refractive anisotropy is set to a twisted alignment of substantially 90° between glass substrates opposed to each other, and optical rotary power of incident light is adjusted by controlling its twisted alignment. Although this TN-mode liquid crystal display panel can be comparatively easily manufactured, its viewing angle is narrow, and its response speed is low. Thus, this panel has been unsuitable to display a moving image such as a television image, in particular.

On the other hand, an optically compensated birefringence (OCB) mode liquid crystal display panel is attracting attention as a liquid crystal display panel which improves the viewing angle and response speed. The OCB-mode liquid crystal display panel contains a liquid crystal material sealed between the opposed glass substrates and capable of providing a bend alignment. The response speed is improved by one digit as compared with the TN-mode liquid crystal display panel. Further, there is an advantage that the viewing angle is wide because optically self compensation is made from an alignment state of the liquid crystal material.

In the OCB-mode liquid crystal display panel, as shown in (a) of FIG. 5, liquid crystal molecules 65 of a liquid crystal layer are set to a splay alignment when no voltage is applied between a pixel electrode 62 disposed on a glass based array substrate 61 and a counter electrode 64 disposed similarly on a glass based counter substrate 63 which is opposed to the array substrate 61. Thus, when a high voltage of the order of some tens of voltages is applied between the pixel electrode 62 and the counter electrode 64 upon supply of power, the liquid crystal molecules 65 are transferred to the bend alignment.

To reliably transfer the alignment state upon high voltage application, voltages opposite in polarity are applied to adjacent horizontal lines of the pixels to create a nucleus by a laterally twisted potential difference between the adjacent pixel electrode 62 and transfer pixel electrode. The alignment state is transferred around the nucleus. Such an operation is carried out for substantially one second, whereby the splay alignment is transferred to the bend alignment. Thereafter, a difference in potential between the pixel electrode 62 and the counter electrode 64 is temporarily eliminated by equalization to cancel an undesired record.

After the liquid crystal molecules 65 have been thus transferred to the bend alignment, a voltage exceeding a low OFF voltage, at which the liquid crystal molecules 65 are maintained in the bend alignment as shown in (b) of FIG. 5, is applied from a drive power supply 66 during operation. The OFF voltage or an ON voltage which is higher than the OFF voltage is applicable from the drive power supply 66 as shown in (c) of FIG. 5. Thus, the drive voltage between the electrodes 62 and 64 changes in the range of the OFF voltage to the ON voltage. Consequently, the alignment state of the liquid crystal molecules 65 is transferred between the bend alignment shown in (b) of FIG. 5 and the bend alignment shown in (c) of FIG. 5 to change a retardation value of the liquid crystal layer, thereby controlling transmittance.

In the case where the OCB-mode liquid crystal display panel is used for displaying an image, birefringence is controlled in association with polarizing plates. The liquid crystal panel is driven by a driver circuit such that light is shielded (for a black display) upon application of a high voltage and is transmitted (for a white display) upon application of a low voltage, for example.

As shown in FIG. 6, this driving circuit has: n×n pixel electrodes 62 arrayed in a matrix on the array substrate 61; n scanning lines (gate lines) G1 to Gn formed along rows of the pixel electrodes 62; n signal lines (source lines) S1 to Sn formed along columns of the pixel electrodes 62; and n×n thin-film transistors (TFTs) 67 which are disposed near intersections between the scanning lines G1 to Gn and the signal lines S1 to Sn as switching elements for the n×n pixel electrodes 62.

Each TFT 67 has a gate electrode 62 connected to one scanning line G, a source electrode connected to one source line S. When the TFT 67 is made conductive by a drive voltage that is applied from a gate driver (scanning line driving circuit) 68 via the scanning line G, a signal voltage from a source driver (signal line driving circuit) 69 is applied via a source-drain path of the TFT 67 to one pixel electrode 62. The TFTs 67 operate in the manner described above.

A liquid crystal layer 70 containing the liquid crystal molecules 65 exists between the pixel electrode 62 and the counter electrode 64, and is further connected in parallel with a storage capacitance 71 that stores a potential equal to that of the pixel electrode 62. The counter electrode 64 is configured to receive a driving voltage supplied from a counter electrode driving circuit (not shown).

In such an OCB-mode liquid crystal display panel, the alignment state can be transferred from the splay alignment unusable for a display to the bend alignment usable for a display, by means of a voltage applied between the pixel electrode 62 and the counter electrode 64. Further in the OCB-mode liquid crystal display panel, a countermeasure is employed to insert black (black signal) into a signal in order to prevent an inverse transfer phenomenon in which the bend alignment is inverse-transferred to the splay alignment.

As shown in FIG. 7, a power source voltage from a power supply circuit 72 is supplied to a voltage dividing resistor unit 73. The voltage dividing resistor unit divides the power source voltage into reference voltages representing gradations for video and black signals. The reference voltages are supplied to the source driver 69.

In this OCB-mode liquid crystal display, when a temperature of a liquid crystal display panel 74 (see FIG. 6) or an external environment temperature changes, a voltage-transmittance relation (VT) also shifts following the temperature change. Therefore, the power supply circuit 72 for the source driver 69 is controlled by a thermistor or the like to cancel dependence on the temperature. Moreover, a black display tends to be reversed especially at a high temperature. Therefore, when the power supply voltage is lowered to prevent the black reverse phenomenon, a black insertion voltage necessarily becomes small which has been derived from the voltage dividing resistor unit 73 connected to the power supply circuit 72. Therefore, an increase of a black insertion ratio is required to prevent the inverse transfer. However, when the black insertion ratio is increased, there has occurred a problem that luminance and contrast drop.

### BRIEF SUMMARY OF THE INVENTION

An object of the present invention is to provide a display panel driving device and flat display device which do not require an increase of a black insertion ratio in order to reliably prevent inverse transfer at a high temperature.

According to a first aspect of the present invention, there is provided a display panel driving device for an OCB-mode liquid crystal display panel, comprising: gate and source drivers which are connected to the liquid crystal display panel; and a voltage supply circuit which supplies video signal reference voltages and black insertion reference voltages to the source driver, the voltage supply circuit being configured to independently generate the video signal reference voltages and the black insertion voltages.

According to a second aspect of the present invention, in the display panel driving device, the above-mentioned voltage supply circuit includes a video signal voltage control circuit which generates the video signal reference voltages and a black insertion voltage control circuit which generates the black insertion voltages, and the video signal reference voltages and the black insertion voltages being independently output to the source driver from the video signal voltage control circuit and the black insertion voltage control circuit, respectively.

According to a third aspect of the present invention, in the display panel driving device, the above-mentioned voltage supply circuit further includes: a switching circuit which switches the video signal reference voltages from the video signal voltage control circuit and the black insertion voltages from the black insertion voltage control circuit; and a voltage dividing resistor unit which divides the voltage from the switching circuit into voltages to be output to the source driver.

According to a fourth aspect of the present invention, there is provided a display panel driving device for an OCB-mode liquid crystal panel which displays an image by a matrix array of pixels each having liquid crystal molecules set in a bend alignment, comprising: a driver circuit which sequentially performs writing for a video signal and writing for a non-video signal that maintains the bend alignment into different rows of pixels in one vertical scanning period; a video signal voltage control circuit which controls a voltage to be written as the video signal by the driver circuit; and a non-video signal voltage control circuit which controls a voltage to be written as the non-video signal by the driver circuit, independently from the video signal voltage control circuit.

According to a fifth aspect of the present invention, there is provided a flat display device comprising: an OCB-mode liquid crystal panel which displays an image by a matrix array of pixels each having liquid crystal molecules set in a bend alignment; a driver circuit which sequentially performs writing for a video signal and writing for a non-video signal for maintaining the bend alignment into different rows of pixels in one vertical scanning period; a video signal voltage control circuit which controls a voltage to be written as the video signal by the driver circuit; and a non-video signal voltage control circuit which controls a voltage to be written as the non-video signal by the driver circuit, independently from the video signal voltage control circuit.

According to a sixth aspect of the present invention, in the flat display device, the above-mentioned video signal voltage control circuit is configured to change the range of the voltage to be written as the video signal, in accordance with the environment where the device is used, and the non-video signal voltage control circuit is configured to set the voltage to be written as the non-video signal into a level equal to or more than a predetermined level at which the bend alignment is maintained.

With the display panel driving device and the flat display device, the video signal reference voltages and the black insertion voltages are generated independently. In this case, an increase in the black insertion voltage is attainable irrespective of the video signal voltage. Further, the voltage to be written as the video signal and the voltage to be written as the non-video signal voltage are controlled independently. In this case, an increase in the voltage to be written as the non-video signal is attainable irrespective of the voltage to be written as the video signal. That is, the black (non-video signal) insertion ratio does not have to be increased in order to reliably prevent the inverse transfer at high temperature, and as a result, it is possible to display a high-quality image whose luminance and contrast are prevented from being lowered.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the circuit configuration of a liquid crystal display panel according to one embodiment of the present invention;

FIG. 2 is a diagram showing an example of the configuration of a circuit for supplying reference voltages to a source driver shown in FIG. 1;

FIG. 3 is a diagram showing a first modification of the circuit shown in FIG. 2;

FIG. 4 is a diagram showing a second modification of the circuit shown in FIG. 2;

FIG. 5 is a diagram for schematically explaining a display operation of a typical OCB-mode liquid crystal display panel;

FIG. 6 is a diagram showing the liquid crystal display panel shown in FIG. 5 together with a driving circuit; and

FIG. 7 is a diagram showing the configuration of a reference voltage generating circuit connected to the driving circuit shown in FIG. 6.

### DETAILED DESCRIPTION OF THE INVENTION

A liquid crystal display device according to one embodiment of the present invention will be described with reference to the accompanying drawings.

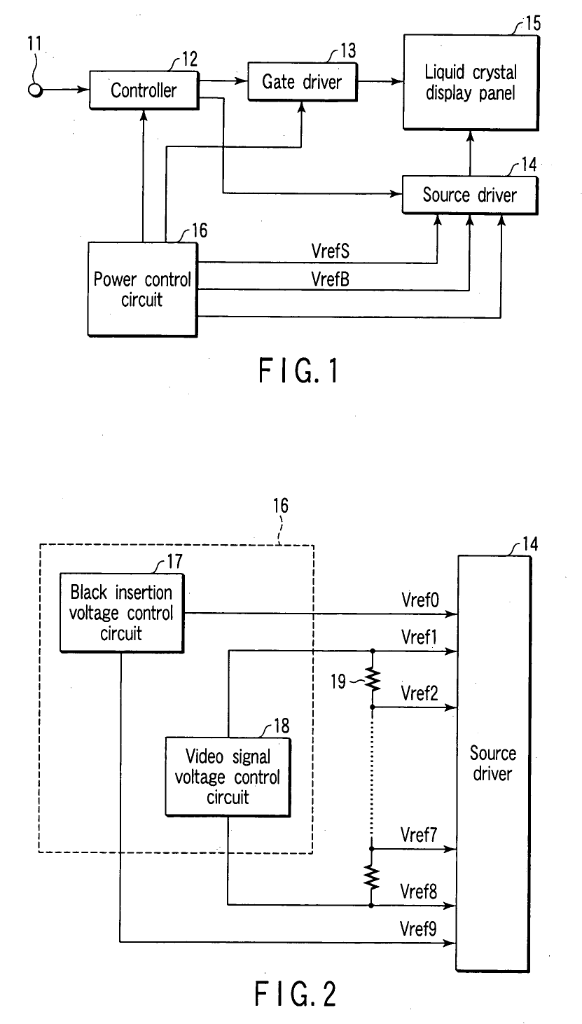

As shown in FIG. 1, in this liquid crystal display, input signals, such as a vertical sync signal defining one vertical scanning period, a horizontal sync signal defining one horizontal scanning period, and a video signal, are input from an input port 11 and supplied to a controller 12. The controller 12 includes a black signal insertion timing setting unit that serves as a black insertion timing determination circuit and a driver control circuit. The driver control circuit generates a timing pulse to insert a black signal on conditions set at the black signal insertion timing setting unit.

In the OCB mode, continuous application of a low voltage allows the alignment state of liquid crystal molecules to be inverse-transferred from the bend alignment to the splay alignment. The black signal is a signal for preventing the inverse transfer phenomenon, and is used as an example of the non-video signal in this embodiment. A write operation for the black signal is called black insertion, and the black signal is inserted at a desired black insertion ratio for each field. The black insertion ratio is controlled as a time difference between the write timing for writing the video signal into a row (line) of the pixels and the write timing for writing the black signal into these pixels, in one field period (one vertical scanning period).

The black insertion timing setting unit sets an appropriate timing for writing or inserting a black signal in one field to effectively prevent occurrence of the inverse transfer phenomenon. The black signal is written at a timing when the predetermined number of the horizontal sync signal pulses have been supplied after a video signal write timing. The black insertion ratio is changeable to arbitrarily shift a black signal write timing for black insertion.

The controller 12 supplies driving signals to a gate driver 13 and a source driver 14. The gate driver 13 and the source driver 14 supply signals such as a gate pulse and the video signal to an OCB-mode liquid crystal display panel 15, respectively.

A power supply control circuit 16 is connected to the gate driver 13, the source driver 14, and the controller 12 to supply predetermined power source voltages. A driving voltage from the power supply control circuit 16 and the gate pulse, the video signal and the like from the controller 12 are used to display a desired image on the liquid crystal display panel 15.

As shown in FIG. 2, the power supply control circuit 16 supplies video signal reference voltages VrefS and black insertion reference voltages VrefB to the source driver 14. The black insertion reference voltages VrefB and the video signal reference voltages VrefS are separately supplied to the source driver 14 from a black insertion voltage control circuit 17 and a video signal voltage control circuit 18, both of which are provided in the power supply control circuit 16.

That is, for example, the black insertion voltage control circuit 17 directly supplies to the source driver 14 as a high reference voltage, voltages Vref0 and Vref9 (corresponding to VrefB), which are of 15 V and 0V, for example. The video signal voltage control circuit 18 supplies voltages Vref1 and Vref8 to ends of a voltage dividing resistor unit 19, which are connected to the source driver 14 in parallel. The voltages Vref1 and Vref8 are set at intermediate levels between the voltages Vref0 and Vref9. In addition to the voltages Vref1 and Vref8, required voltages Vref2 to Vref7 obtained from intermediate points of the voltage dividing resistor unit 19 are supplied to the source driver 14.

As described above, individual configuration and individual connection are employed to obtain the black insertion voltage control circuit 17 and the video signal voltage control circuit 18 which are independent from each other. Thus, a black insertion voltage is controllable by the black insertion voltage control circuit 17 irrespective of the setting of the video signal voltage control circuit 18. Therefore, the black insertion voltage can be increased by the black insertion voltage control circuit 17 even at the high temperature. Accordingly, the black insertion ratio can be set to a small value. Therefore, it is possible to inhibit a problem of drop of luminance or contrast from being caused by an increase of the black insertion ratio.

Furthermore, a temperature of the liquid crystal display panel 15 itself or an external environment surrounding the panel is detected, for example, by a thermistor or the like. When the black insertion voltage control circuit 17 is controlled in accordance with the detected temperature, and the temperature is high, the timing of the black insertion is controlled, or the black insertion voltage is controlled to be low. Accordingly, it is possible to suppress the drop of the contrast of the liquid crystal display panel 15. With this configuration, when the thermistor or the like detects a temperature change by a change of the temperature of the liquid crystal display panel 15 itself or an ambient temperature, it is possible to change the black insertion ratio in conjunction with the temperature change. Therefore, the black signal insertion timing can be set to be optimum in accordance with a use state.

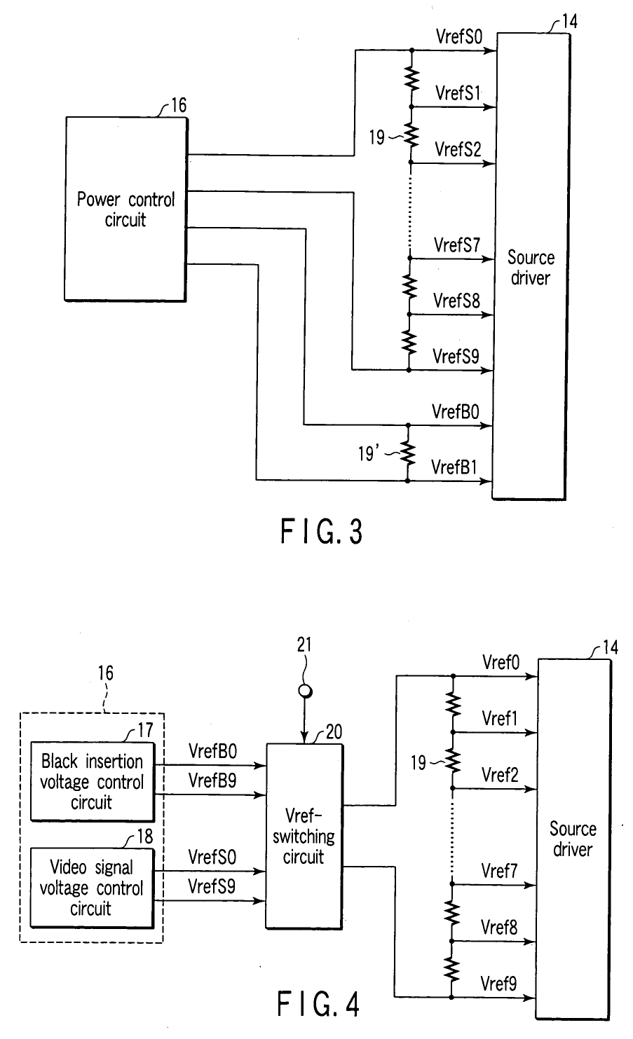

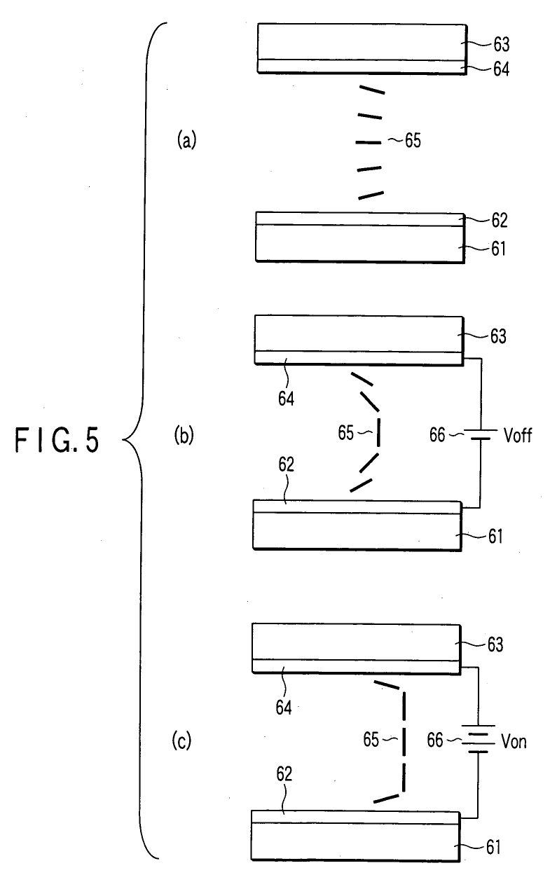

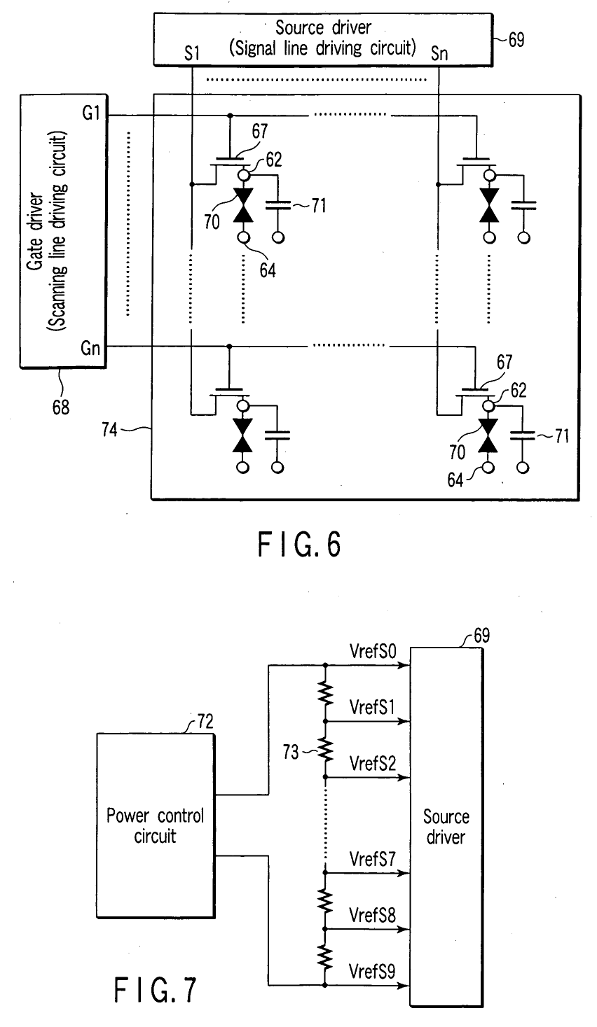

In the present embodiment, it has been described that the voltage dividing resistor unit 19 is connected to the video signal voltage control circuit 18, and the black insertion voltage control circuit 17 is directly and independently connected to the source driver 14. However, as shown in FIG. 3, a resistor circuit 19′ for the black insertion voltage control circuit 17 may be provided separately from the voltage dividing resistor unit 19 for the video signal voltage control circuit 18 to obtain video signal reference voltages VrefS0 to VrefS9 and black insertion reference voltages VrefB0 and VrefB1 from voltages supplied from a single power supply control circuit 16 and supply these voltages to the source driver 14. Even with this configuration, the source driver 14 can be similarly driven.

In any case, there has been described the circuit configuration in which the black insertion reference voltages and the video signal reference voltages are supplied to the source driver 14 via different routes, but it is also possible to provide another display panel driving device in which the black insertion reference voltages and the video signal reference voltages are supplied commonly via a single voltage dividing resistor unit.

That is, as shown in FIG. 4, the black insertion voltage control circuit 17 supplies voltages VrefB0 and VrefB9 to a Vref-switching circuit 20, and the video signal voltage control circuit 18 supplies voltages VrefS0 and VrefS9 to the Vref switching circuit 20. The Vref switching circuit 20 is controlled to perform switching between the voltages from the black insertion voltage control circuit 17 and the voltages from the video signal voltage control circuit 18 in accordance with a switching signal supplied from the controller 12 to an input terminal 21. Output voltages from the Vref-switching circuit 20 are supplied to ends of the voltage dividing resistor unit 19 which are connected to the source driver in parallel, so as to obtain the voltages Vref0 to Vref9 and supply these voltages to the source driver 14.

In the above-described configuration, the voltages from the black insertion voltage control circuit 17 and the voltages from the video signal voltage control circuit 18 are switched by the Vref-switching circuit 20 and supplied to the voltage dividing resistor unit 19 for a black insertion period and for a video signal period, respectively. Accordingly, the reference voltages supplied to the source driver 14 can be optimized for the video signal or the black signal. Since the outputs from the black insertion voltage control circuit 17 and the voltage control circuit 18 for the video signal are supplied commonly via the voltage dividing resistor unit 19 to the source driver 14, not via a separate route, it is possible to simplify circuit wiring that includes the voltage dividing resistor unit 19 on a source driver 14 side.

It is to be noted that it has been described above in the embodiment that video signal reference voltages are provided, but the number of the reference voltages can appropriately be set to attain required gradations. Moreover, a configuration of the voltage dividing resistor unit is not limited to a shown configuration, and replaced by another configuration of the voltage dividing resistor unit that has a combination of parallel resistors, or an active element, or a switching element.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A display panel driving device for an OCB-mode liquid crystal display panel, comprising:
gate and source drivers which are connected to the liquid crystal display panel; and
a voltage supply circuit which supplies video signal reference voltages and black insertion reference voltages to the source driver, the voltage supply circuit being configured to independently generate the video signal reference voltages and the black insertion voltages.

2. The display panel driving device according to claim 1, wherein the voltage supply circuit includes a video signal voltage control circuit which generates the video signal reference voltages and a black insertion voltage control circuit which generates the black insertion voltages, and the video signal reference voltages and the black insertion voltages being independently output to the source driver from the video signal voltage control circuit and the black insertion voltage control circuit, respectively.

3. The display panel driving device according to claim 2, wherein the voltage supply circuit further includes:
a switching circuit which switches the video signal reference voltages from the video signal voltage control circuit and the black insertion voltages from the black insertion voltage control circuit; and
a voltage dividing resistor unit which divides the voltage from the switching circuit into voltages to be output to the source driver.

4. A display panel driving device for an OCB-mode liquid crystal panel which displays an image by a matrix array of pixels each having liquid crystal molecules set in a bend alignment, comprising:
a driver circuit which sequentially performs writing for a video signal and writing for a non-video signal that maintains the bend alignment into different rows of pixels in one vertical scanning period;
a video signal voltage control circuit which controls a voltage to be written as the video signal by the driver circuit; and
a non-video signal voltage control circuit which controls a voltage to be written as the non-video signal by the driver circuit, independently from the video signal voltage control circuit.

5. A flat display device comprising:
an OCB-mode liquid crystal panel which displays an image by a matrix array of pixels each having liquid crystal molecules set in a bend alignment;
a driver circuit which sequentially performs writing for a video signal and writing for a non-video signal for maintaining the bend alignment into different rows of pixels in one vertical scanning period;
a video signal voltage control circuit which controls a voltage to be written as the video signal by the driver circuit; and
a non-video signal voltage control circuit which controls a voltage to be written as the non-video signal by the driver circuit, independently from the video signal voltage control circuit.

6. The flat display device according to claim 5, wherein the video signal voltage control circuit is configured to change the range of the voltage to be written as the video signal, in accordance with an environment where the device is used, and the non-video signal voltage control circuit is configured to set the voltage to be written as the non-video signal into a level equal to or more than a predetermined level at which the bend alignment is maintained.
